(19) United States
(12) Patent Application Publication
(10) Pub. No.: US 2007/0042628 A1
(43) Pub. Date: Feb. 22, 2007

(54) Sanitary, live loaded, pass through fitting apparatus

(75) Inventor: Daniel Lyon, Ridgefield, CT (US)

Correspondence Address: Daniel Lyon, 912 North Salem Road, Ridgefield, CT, 06877, US

(73) Assignee: Daniel Lyon

(21) Appl. No.: 11/500,693

(22) Filed: Aug. 9, 2006

Related U.S. Application Data
(60) Provisional application No. 60/709,061, filed on Aug. 17, 2005.

(51) Int. Cl. H01R 13/52

(52) U.S. Cl. 439/271

(57) ABSTRACT

A sanitary, live loaded, pass through fitting apparatus which allows for the variable insertion of a cylindrically shaped pass through object such as, but not limited to, a thermowell probe or dip tube with out introducing contamination or microbial growth into a sanitary process stream or vessel, utilizing a supported, partially exposed packing seal. The cylindrically shaped pass through object such as but not limited to, a thermowell probe or dip tube is sealed to the fitting at the point of fluid insertion, with complete and constant exposure to the flow of the process media. The seal material is under a live load to compensate for wear and or thermal cycling.

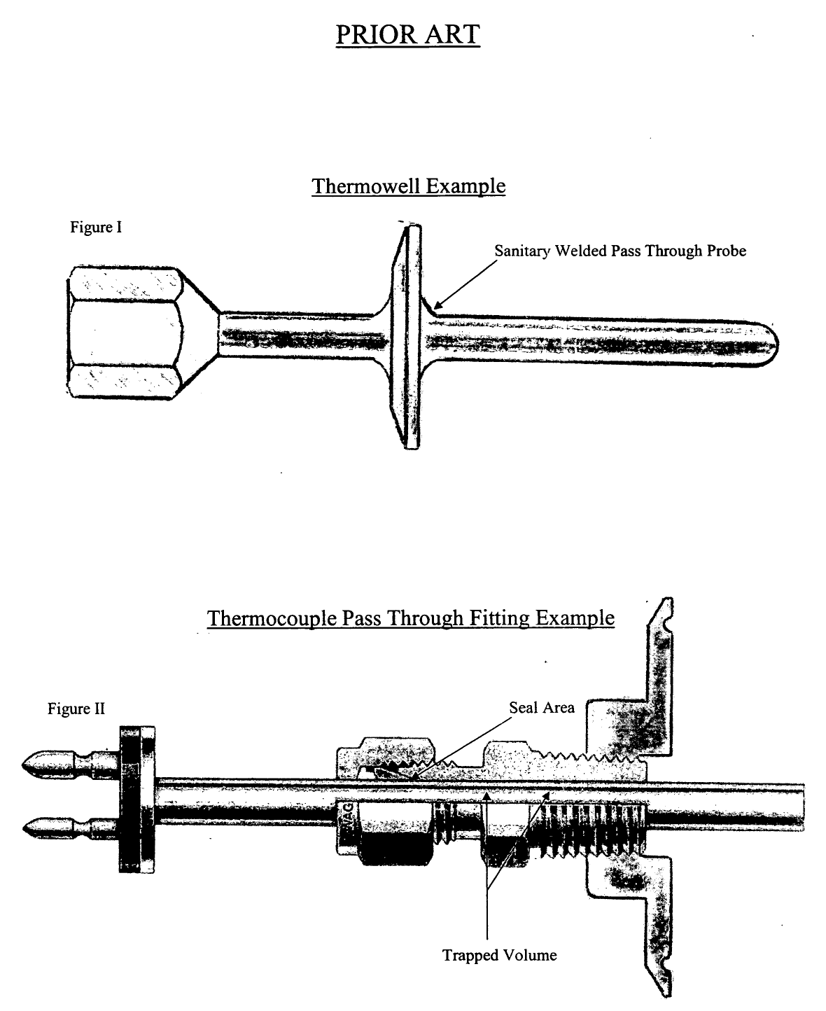

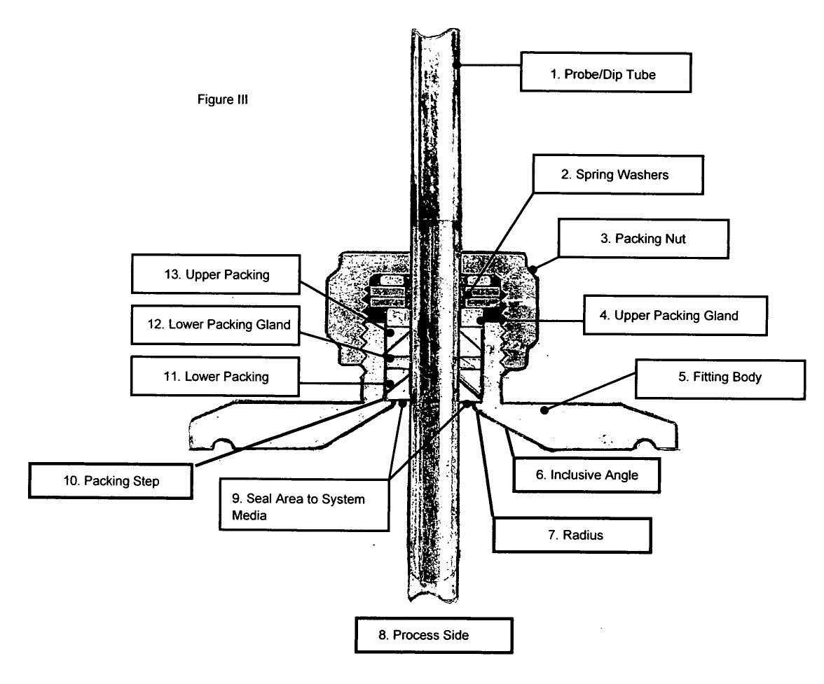

### PROVISIONAL PATENT BENEFIT REQUEST

This application claims priority from the following provisional patent application:

Confirmation Number: 4615

Application No. 60/709,061

Filing Date: Aug. 17, 2005

### DESCRIPTION

### Field of the Invention

Many process industries such as power, chemical, and biopharmaceutical, require thermal or other types of monitoring, sampling, and injection of fluids for proper manufacturing. This is accomplished by inserting a cylindrically shaped probe or tube, such as but not limited to*, a thermowell probe or dip tube into a process stream or a vessel containing process fluid.
* For example: a valve stem employing the preferred embodiments of the invention.

### BRIEF DESCRIPTION OF THE DRAWINGS

The present invention and prior art is further described with reference to the accompanying drawings. Figure III depicts the embodiments of the present invention. Please note that the invention as disclosed in the accompanying drawings is illustrated by way of example only. The various elements and combinations of elements described below and illustrated in the drawings can be arranged and organized differently to result in embodiments which are still within the spirit and scope of the present invention.

Figure I: Thermowell example: an example of a probe welded to a sanitary fitting for temperature measurement. The design is clean, but the probe insertion depth is not variable.

Figure II: Thermocouple Pass Through Fitting: an example of an industrial thermocouple fitting threaded into a sanitary cap. The insertion depth of the probe is variable, but the fitting has too much entrapment to be sanitary. Variable but not clean.

Figure III: Sanitary, Live Loaded Pass Through Fitting Apparatus: The subject of this application. The probe or sample tube can be inserted to an optimal depth and is free of entrapment zones. Please note that figure III depicts the invention integrated to a sanitary cap fitting: a common application. The invention can be integrated with other types of fittings, flanges or tubing while retaining the preferred embodiments.

### PRIOR ART

For biopharmaceutical applications, objects with cylindrical geometry, such as but not limited to, thermowell probes or dip tubes, are typically welded and sealed in place to a sanitary fitting (figure I) at a predetermined length for the insertion depth. Although this design is with out entrapment areas, it does not allow for variable insertion depth of a probe or tube once it has been manufactured.

Variable insertion depth of a thermowell or dip tube is desirable for certain applications in order to locate the optimal sensing, sampling, or injection point in the process stream. Variable insertion depth of a probe or tube can be accomplished using a pass through thermocouple fitting (reference U.S. Pat. No. 4,137,768).

These fittings however seal to the probe or tube away from the process stream and trap process fluid (figure II). This design is acceptable for industrial applications, but not for biopharmaceutical systems where entrapment leads to microbial growth or chemical contamination. This in turn may render the sanitary process fluid unacceptable for use.

### DESCRIPTION OF THE PREFERRED EMBODIMENTS

A cylindrically shaped pass through object (figure III), such as but not limited to a thermowell probe or dip tube 1 is inserted through the packing nut and fitting internals into a process stream to the desired sensing or sampling point. As the packing nut 3 is tightened, an axial load is translated to the spring washers 2, and in turn to the packing glands 12, 13 and packing seals 4, 11. An axial seal is made by the lower packing 11, such as but not limited to a chevron packing, to the packing step 10 on the lower interior portion of the pass through fitting body. A radial seal 9 is created to the cylindrically shaped pass through object at its point of insertion into the process stream.

The process side 8 of the pass through fitting body employs the use of an inclusive angle 6 terminating in a radius 7 to the partially exposed lower packing 11 in a manor that is cleanable and drainable in a horizontal or vertical orientation. A By loosening and retightening the packing nut 3, the insertion depth of the cylindrical object 1 can be adjusted to an optimum sensing or sample point. The spring washers 2 compensate for wear and thermal cycling of the packing components, aiding in the leak tightness of the apparatus.

The upper packing 13 serves to grip and provide lateral support with out damage to a cylindrically shaped pass through object.

The upper and lower packing glands 4, 12 serve to properly load and contain the packing.

What is claimed is:

1. A sanitary, live loaded pass through fitting apparatus, comprising of a fitting body and partially exposed packing seal, such as but not limited to, a chevron style packing, which facilitates the variable insertion depth of, and seals to, a cylindrically shaped pass through object, such as but not limited to, a thermowell type probe or dip tube with out conventional entrapment areas that create contamination.
A partially exposed packing seal is made to a cylindrically shaped pass through object and the fitting body at the insertion point into the process stream. The improvement comprising of a seal with all wetted components under constant exposure and flow of the process media, (therefore being cleanable and drainable) while also allowing for the variable insertion depth of a cylindrically shaped pass through object.

2. Furthering claim one: the process side of the pass through fitting body apparatus comprises of an inclusive angle terminating in a radius to a partially exposed lower packing seal, such as but not limited to a chevron packing, in a manor that is cleanable and drainable in a horizontal or vertical orientation. The partial exposure of the lower packing consists of a precise gap between the radius of the fitting body and the cylindrically shaped object such as but not limited to a thermowell probe or dip tube.
The improvement comprising of a fitting apparatus which allows for the use of, but is not limited to, polymers such as PTFE: (preferred for its inertness to most process medias) as a dynamic, yet sanitary seal for cylindrically shaped objects.

3. A live loaded spring washer(s) apparatus under a load from a packing nut which exerts a constant force on the seal material. The improvement comprising of an apparatus that compensates for wear or thermal cycling of the packing seal. Live loaded sealing has been utilized for valve stem seals to control leakage or “fugitive emissions”. This new use for a proven design in a sanitary pass through fitting has the same benefits.

4. Furthering claims one, two, and three, as the packing nut is tightened, an axial load is translated to the spring washers, and in turn to the packing glands. An axial seal is made by the lower packing, such as but not limited to a chevron packing, to the packing step on the lower interior portion of the pass through fitting body. A radial seal is also created by the lower packing to the cylindrically shaped pass through object such as but not limited to a thermowell probe or dip tube at its point of insertion into the process stream.
The upper packing serves to grip and provide lateral support with out damage to a cylindrically shaped pass through object. The upper and lower packing glands serve to properly load and contain the upper and lower packing.
